(19) United States
(12) Patent Application Publication
(10) Pub. No.: US 2013/0037527 A1
(43) Pub. Date: Feb. 14, 2013

(54) Fixture for Drilling Vias in Back-Contact Solar Cells

(71) Applicants: Jeffrey L. Franklin, Albuquerque, NM (US); James M. Gee, Albuquerque, NM (US)

(72) Inventors: Jeffrey L. Franklin, Albuquerque, NM (US); James M. Gee, Albuquerque, NM (US)

(73) Assignee: Applied Materials, Inc., Santa Clara, CA (US)

(21) Appl. No.: 13/204,801

(22) Filed: Aug. 8, 2011

(51) Int. Cl. B23K 26/38; B23Q 3/00; B25B 11/00

(52) U.S. Cl. 219/121.71; 219/121.7; 219/121.82; 269/21; 269/296

(57) ABSTRACT

Methods and systems for manufacturing back contact solar cells that have improved efficiency and device electrical properties. the solar cell device described herein includes an Emitter Wrap Through (EWT) solar cell that has plurality of laser drilled vias disposed in a spaced apart relationship to metal gridlines formed on a surface of the substrate. Solar cell structures that may benefit from the invention disclosed herein include back-contact solar cells, such as those in which both positive and negative contacts are formed only on the rear surface of the device.

### BACKGROUND

Embodiments of the present invention generally relate to apparatus and methods for making back-contact silicon solar cells and solar cells made by such methods. More specifically, embodiments of the invention are directed to fixtures for laser drilling back-contact solar cells and methods use.

The solar cell design in widespread use today has a p/n junction formed near the front surface (that surface which receives the light) which creates an electron flow as light energy is absorbed in the cell. The conventional cell design has one set of electrical contacts on the front side of the cell, and a second set of electrical contacts on the back side of the solar cell. In a typical photovoltaic module these individual solar cells are interconnected electrically in series to increase the voltage. This interconnection is typically accomplished by soldering a conductive ribbon from the front side of one solar cell to the back side of an adjacent solar cell.

Back-contact silicon solar cells have several advantages compared to conventional silicon solar cells. The first advantage is that back-contact cells have a higher conversion efficiency due to reduced or eliminated contact obscuration losses (sunlight reflected from contact grid is unavailable to be converted into electricity). The second advantage is that assembly of back-contact cells into electrical circuits is easier, and therefore cheaper, because both conductivity type contacts are on the same surface. As an example, significant cost savings compared to present photovoltaic module assembly can be achieved with back-contact cells by encapsulating the photovoltaic module and the solar cell electrical circuit in a single step. The last advantage of a back-contact cell is better aesthetics through a more uniform appearance. Aesthetics is important for some applications, such as building-integrated photovoltaic systems and photovoltaic sunroofs for automobiles.

FIG. 1 illustrates a generic back-contact cell structure 100. The silicon substrate 102 may be n-type or p-type. One of the heavily doped emitters (n⁺⁺ 104 or p⁺⁺ 106) may be omitted in some designs. Alternatively, the heavily doped emitters could directly contact each other on the rear surface in other designs. Rear-surface passivation 108 helps reduce loss of photogenerated carriers at the rear surface and helps reduce electrical losses due to shunt currents at undoped surfaces between the contacts 110, 112.

There are several approaches for making a back-contact silicon solar cell. These approaches include metallization wrap around (MWA), metallization wrap through (MWT), emitter wrap through (EWT), and back-junction structures. MWA and MWT have metal current collection grids on the front surface. These grids are, respectively, wrapped around the edge or through holes to the back surface in order to make a back-contact cell. The unique feature of EWT cells, in comparison to MWT and MWA cells, is that there is no metal coverage on the front side of the cell, which means that none of the light impinging on the cell is blocked, resulting in higher efficiencies. The EWT cell wraps the current-collection junction (“emitter”) from the front surface to the rear surface through doped conductive channels in the silicon wafer. “Emitter” refers to a heavily doped region in a semiconductor device. Such conductive channels can be produced by, for example, drilling holes in the silicon substrate with a laser and subsequently forming the emitter inside the holes at the same time as forming the emitter on front and rear surfaces. Back-junction cells have both the negative and positive polarity collection junctions on the rear surface of the solar cell. Because most of the light is absorbed—and therefore also most of the carriers are photogenerated—near the front surface, back-junction cells require very high material quality so that carriers have sufficient time to diffuse from the front to the rear surface with the collection junctions on the rear surface. In comparison, the EWT cell maintains a current collection junction on the front surface, which is advantageous for high current collection efficiency. The EWT cell is disclosed in U.S. Pat. No. 5,468,652, Method Of Making A Back Contacted Solar Cell, to James M. Gee, incorporated here in full. The various other back contact cell designs have also been discussed in numerous technical publications.

In addition to U.S. Pat. No. 5,468,652, two other U.S. patents on which Gee is a co-inventor disclose methods of module assembly and lamination using back-contact solar cells, U.S. Pat. No. 5,951,786, Laminated Photovoltaic Modules Using Back-Contact Solar Cells, and U.S. Pat. No. 5,972,732, Method of Monolithic Module Assembly. Both patents disclose methods and aspects that may be employed with the invention disclosed herein, and are incorporated by reference as if set forth in full. U.S. Pat. No. 6,384,316, Solar Cell and Process of Manufacturing the Same, discloses an alternative back-contact cell design, but employing MWT, wherein the holes or vias are spaced comparatively far apart, with metal contacts on the front surface to help conduct current to the rear surface, and further in which the holes are lined with metal.

An issue for any back-contact silicon solar cell is developing a low-cost process sequence that also electrically isolates the negative and positive polarity grids and junctions. The technical issue includes patterning of the doped layers (if present), passivation of the surface between the negative and positive contact regions, and application of the negative and positive polarity contacts.

Therefore, there is an ongoing need to provide methods to improve the manufacturing and reliability of back-contact solar cells.

### SUMMARY OF THE INVENTION

One embodiment of the present invention are directed to apparatus for drilling a high density of via holes in a semiconductor substrate during the manufacture of a back-contact solar cell. The apparatus comprises a laser, a semiconductor substrate support fixture and a vacuum source. The laser has power sufficient to form the high density via holes in the semiconductor substrate. The semiconductor substrate support fixture is spaced from the laser. The support fixture substantially comprises ceramic material. The support fixture includes a main body portion, a plurality of apertures through the main body portion, and a plurality of spaced apart standoffs. The standoffs contact the semiconductor substrate and hold the semiconductor substrate at a distance away from the main body portion of the fixture. The vacuum source is coupled to the apparatus to supply a vacuum pressure through the apertures in the support fixture sufficient to hold the semiconductor substrate during the high density via hole drilling process.

Additional embodiments of the invention are directed to methods of processing a semiconductor substrate. A semiconductor substrate is positioned on a plurality of standoffs on a support fixture. The support fixture substantially comprises ceramic material. The standoffs hold the substrate a distance from a main body of the support fixture and the support fixture includes a plurality of apertures. A plurality of via holes are drilled in the semiconductor substrate with a laser.

In some embodiments, the semiconductor substrate is held a distance from the main body sufficient to allow the laser to become defocused. In specific embodiments, the semiconductor substrate is positioned a distance from the main body in the range of about 0.5 mm to about 5 mm.

In detailed embodiments, the plurality of standoffs are positioned to rest on bond pad regions of the semiconductor substrate. In one or more embodiments, the top of the plurality of standoffs have chamfered tops. The plurality of standoffs in some embodiments are integrally formed with the main body portion. In some embodiments, the main body portion and the plurality of standoffs are formed separately.

In some embodiments, the ceramic material comprises alumina. In detailed embodiments, the ceramic material has a melting point that minimizes ablation of the ceramic material during a high density via hole drilling process to decrease shunt resistance in a finished back contact solar cell.

In one or more embodiments, a back-contact solar cell manufactured with the apparatus has a lower reverse bias defect than a back-contact solar cell manufactured without the support fixture.

Some embodiments further comprise applying a vacuum sufficient to hold the semiconductor substrate against the standoffs during the high density via hole drilling process. In detailed embodiments, the semiconductor substrate is held a distance from the main body sufficient to allow the laser to become defocused.

Further embodiments of the invention are directed to semiconductor support fixtures comprising a main body portion with a plurality of apertures and a plurality of spaced apart standoff configured to contact a semiconductor substrate and hold the semiconductor substrate a distance from the main body portion. The main body portion of the fixture and the spaced apart standoffs substantially comprise ceramic material. In detailed embodiments, the ceramic material is alumina.

The foregoing has outlined rather broadly certain features and technical advantages of the present invention. It should be appreciated by those skilled in the art that the specific embodiments disclosed may be readily utilized as a basis for modifying or designing other structures or processes within the scope present invention. It should also be realized by those skilled in the art that such equivalent constructions do not depart from the spirit and scope of the invention as set forth in the appended claims.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is an illustration of a generic back-contact solar cell, highlighting only features on the back surface;

FIG. 2 is a top view of a drilling fixture in accordance with one or more embodiments of the invention;

FIG. 3 is a side view of the drilling fixture of FIG. 2;

FIG. 4 shows a perspective view of the drilling fixture of FIG. 2;

FIG. 5 shows an apparatus for drilling a high density of vias in a semiconductor substrate in accordance with one or more embodiments of the invention;

FIG. 6 shows an image of the back view of a semiconductor substrate with laser drilled vias generated with and without a drilling fixture of one or more embodiments of the invention; and

FIGS. 7A and 7B show FLIR images of vias drilled with and without the fixture of one or more embodiments of the invention.

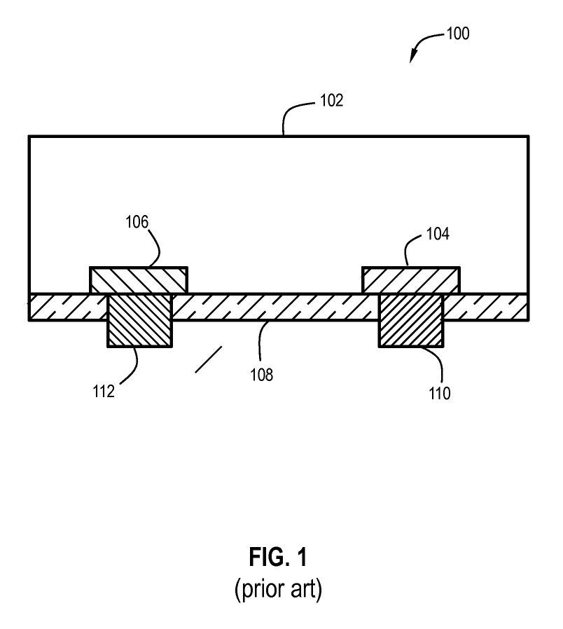

### DETAILED DESCRIPTION

The emitter-wrap-through (EWT) silicon solar cell is a back-contact solar cell without any grids on the front surface. Instead of busbars, the EWT solar cell has many printed silver bondpad areas on the rear surface that will be the contact points with the module backsheet. The fabrication of an EWT cell uses a laser to drill holes in the silicon substrate. The emitter (n+ junction on the surface of the p-type Si substrate) is diffused on the front surface, rear surface, and on the surfaces inside the holes—thereby forming a conductive channel (“via”) from the front surface to the rear surface to enable the back-contact cell design. The emitter has limited conductivity, with typical values between 30 and 150 ohms/square. A high density of vias (typically between 0.5 and 5 holes per mm²) is therefore necessary to limit the resistance losses due to current flow in the front emitter and in the vias. A 156-mm by 156-mm EWT Si solar cell may require up to 120,000 holes. Creating a via usually requires somewhere between 4 and 20 pulses per hole to get through the wafer depending on the type and power of the laser being used.

Once the hole is completed, the laser will pass through to the fixture beneath. Because of the high density of holes it is nearly impossible to avoid the laser interacting with the fixture material as well. Hence, the EWT cell requires a fixture that is specifically designed for this process. The drilling process using a typical machined aluminum fixture will result in the ablation of aluminum. The ablated fixture material will then interact with the rear side of the solar cell. Aluminum and other similar metals easily diffuse into silicon and can even survive the chemical etching process. This results in areas of high localized shunting that will cause decreased shunt resistance and elevated reverse bias values.

Embodiments of the invention use both a material and fixture design that minimizes this rear side contamination. Aluminum oxide (Al₂O₃), also referred to as alumina, is a ceramic that is commonly used in the laser industry because of high melting point and low absorption characteristics. It can be machined to very precise dimensions and maintain the flatness requirements necessary for the laser drilling process. By using this as the fixture material it greatly reduces the risk of contaminating the rear surface of the solar cell with metal. The design of the fixture is such that the solar cell is only supported in the bond pad regions where there are less vias. Vacuum is applied from below the fixture and flows through the many holes in the fixture. This then pulls the solar cell to the raised posts on the fixture. This creates a space between the solar cell and the fixture in all areas except the posts which are in the bond pad areas. The result is little or no rear contamination from the fixture during the drilling process.

As used herein, Emitter Wrap Through (EWT) solar cell refers to solar cells that have reduced area busbars, or that are entirely busbarless, and current is extracted from a variety of points on the interior of the cell surface. Holes connect the front surface of the wafer to the rear surface, and are formed by laser drilling. In one or more embodiments, a laser of sufficient power or intensity at the operating wavelength is employed such that holes can be introduced at the shortest time, such as from about 0.5 ms to about 5 ms per hole. One laser that may be employed is a Q-switched Nd:YAG laser. By the use of thinner wafers the time per hole is proportionally reduced. The diameter of the via hole may be from about 25 to 125 μm diameter, preferably from about 30 to 60 μm diameter. In one embodiment employing thin wafers, such as wafers with a thickness of 100 μm or less, the via hole diameter is approximately greater than or equal to the wafer thickness. The via hole density per surface area is dependent, in part, on the acceptable total series resistance loss due to current transport in the emitter through the holes to the rear surface. This may be determined either empirically or by theoretical calculations; by the methods of this invention the via hole density may be decreased due to decreased resistance, such as determined by Q./sq. Typically the via hole density is one hole per 1 mm² to 2 mm² surface area, but may be a lower density, such as one hole per 2 to about 4 mm².

A simplified process for manufacturing EWT solar cells includes (1). laser drill holes in silicon wafer; (2) alkaline etch; (3) POCl₃ diffusion to produce n⁺ diffusion on all free surfaces; (4) HF etch; (5) PECVD nitride on front surface; (6) PECVD nitride on rear surface; (7) Laser drill (ablate) (or scribe) and etch pits for the p-type contacts (optional); (8) print Al for p-type contacts; (9) alloy Al (optionally through PECVD nitride layer); (10) print Ag for negative conductivity type grid; (11) print Ag for positive conductivity type grid; and (12) fire the contacts. Embodiments of the invention provide apparatus and methods for laser drilling holes in the silicon wafer.

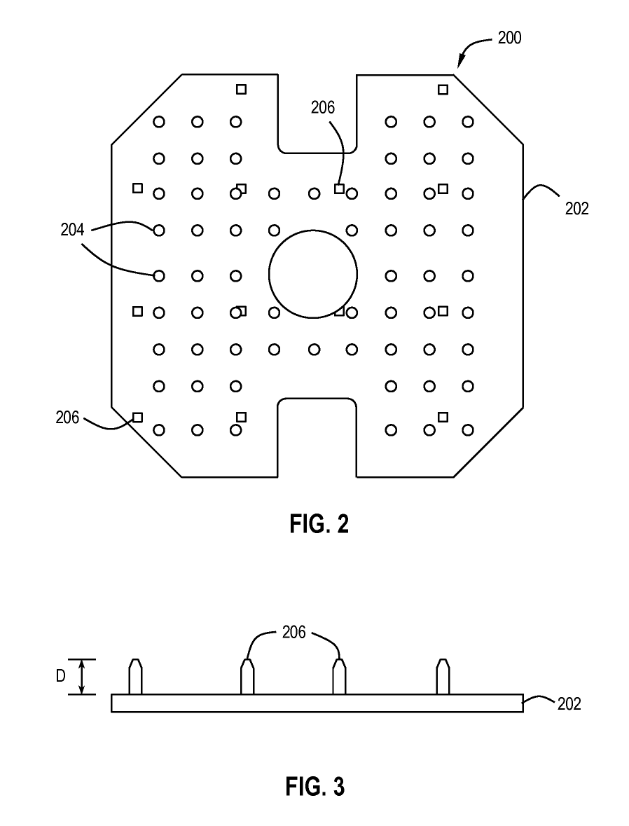

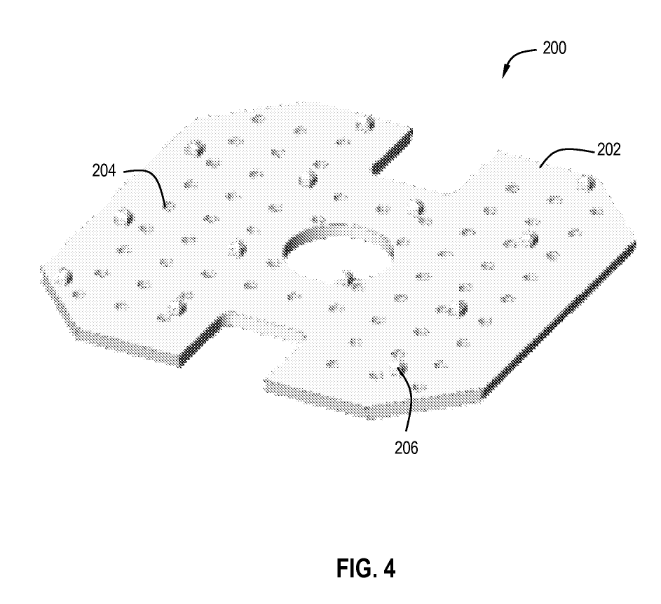

Accordingly, one or more embodiments of the invention are directed to semiconductor support fixtures. FIG. 2 shows a top view of a support fixture in accordance with one or more embodiments of the invention. FIG. 3 shows a side view of the support fixture of FIG. 2 and FIG. 4 shows a perspective view of the fixture. With reference to FIGS. 2 through 4, the support fixture 200 comprises a main body portion 202 with a plurality of apertures 204. A plurality of spaced apart standoffs 206 are configured to contact a semiconductor substrate and hold the substrate a distance D from the main body portion 202.

The height of the standoffs 206 can be changed depending on the specific instrumentation employed. By changing the height of the standoffs 206, the distance D that the substrate is held from the main body 202 can be modified. Where stronger lasers are employed for drilling, it may be desirable to increase the distance D that the substrate is held from the main body portion 202. Without being bound by any particular theory of operations, it is believed that increasing the distance D may ensure that the laser becomes sufficiently defocused before interacting with the main body portion 202. If sufficiently defocused, the effect of the laser (e.g., ablation) of the main body portion 202 can be minimized. In detailed embodiments, the plurality of standoffs 206 have a height sufficient to hold the semiconductor substrate a distance from the main body portion 202 in the range of about 1 mm to about 5 mm. In various embodiments, the substrate is held a distance from the main body portion 202 of at least about 0.5 mm, 1 mm, 2 mm, 3 mm, 4 mm or 5 mm. The distance that the substrate is held from the main body portion 202 may be dependent on the power of the drilling laser. Higher power lasers will generally benefit from a larger distance between the substrate and the main body portion than lower power lasers.

The semiconductor support fixture 200 can be made of any suitable material including, but not limited to, metals, alloys, nonmetal and oxides thereof. However, ceramic materials may be most suitable as these materials have higher melting points and absorb less of the laser's radiation. In detailed embodiments, the semiconductor support fixture 200 is made of a refractory metal oxide. In specific embodiments, the support fixture 200 is made of alumina. In one or more embodiments, the ceramic material has a melting point that minimizes ablation of the ceramic material during the high density via hole drilling process to decrease the shunt resistance in a finished back-contact solar cell. The support fixture 200 of detailed embodiments substantially comprises ceramic material. As used in this specification and the appended claims, the term “substantially comprising ceramic material” means that at least about 90% of the main body portion 202 of the fixture is made of ceramic material.

The shape of the plurality of standoffs 206 can be modified as needed. FIGS. 2-4 show standoffs 206 with a tapered or chamfered top. This is merely illustrative and should not be taken as limiting the scope of the invention. In some embodiments, the top of the standoffs are flat, rounded or pointed.

In some embodiments, the plurality of standoff 206 are integrally formed with the main body portion 202, as from a single piece of material. In one or more embodiments, the standoffs 206 are formed separately from the main body portion 202. In these embodiments, the standoffs 206 can be made from the same material as the main body portion 202 or from different materials. For example, the main body portion 202 can be made of alumina and the standoffs from a different material.

The location of the plurality of standoffs 206 on the main body portion 202 of the fixture 200 can have an impact on the resultant device. If the laser drills a hole in the substrate directly over a standoff, material can be ablated from the standoff, impacting the shunt resistance of the finished product. To minimize the potential impact of the standoffs, the position can be adjusted such that they rest on bond pad regions of the semiconductor substrate.

The specific shape of the fixture 200 is not important, but it may be useful to have the size of the fixture roughly match the size of the substrate being used. Different fixtures may be used with different sized substrates and in different processing chambers. FIG. 2 shows a fixture 200 with a generally square shape with the corners cut off and notches along the top and bottom. These are merely illustrative and should not be taken as limiting the scope of the invention. The various cutouts shown may be present due to other equipment, devices and parts located in the processing chamber.

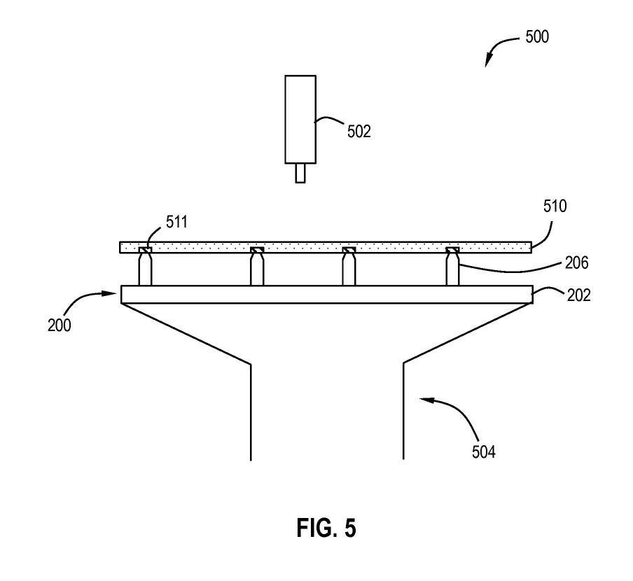

Additional embodiments of the invention are directed to apparatus for drilling a high density of via holes in a semiconductor substrate during the manufacture of a back-contact solar cell. With reference to FIG. 5, the apparatus 500 includes a laser 502, a semiconductor substrate support fixture 200 and a vacuum source 504. The laser 502 has sufficient power to form the high density via holes in the semiconductor substrate. The semiconductor substrate support fixture is spaced from the laser 502. The fixture has a plurality of apertures through the main body portion. These apertures are not visible in FIG. 5, but can be seen in FIGS. 2 through 4. A plurality of spaced apart standoffs 206 are positioned to contact a semiconductor substrate 510 and support the substrate 510 a distance away from the main body portion 202 of the fixture 200. The vacuum source 504 is coupled to the apparatus 500 to supply a vacuum pressure through the apertures in the support fixture 200. The vacuum pressure is sufficient to hold the semiconductor substrate 510 to the standoffs 206 during the high density via hole drilling process. The support fixture 200 shown has standoffs 206 positioned to contact bond pad regions 511 of the substrate 510. These bond pad regions 511 may be formed already, or can be intended to be formed in these positions.

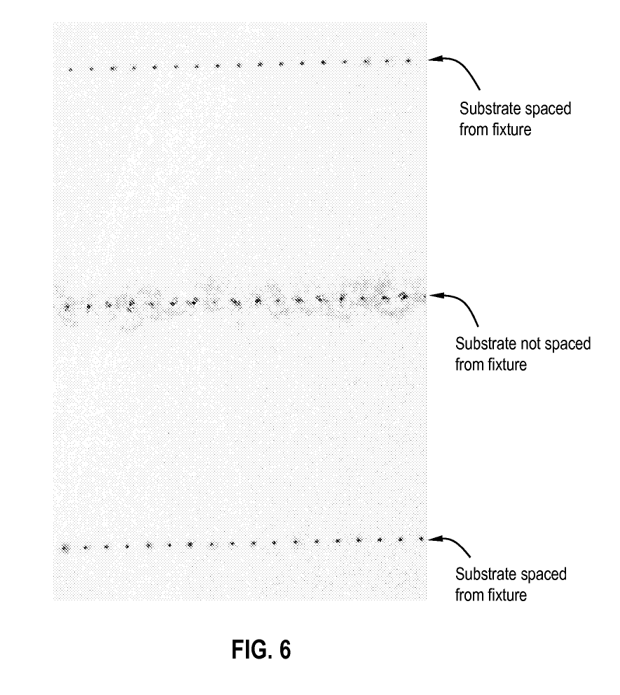

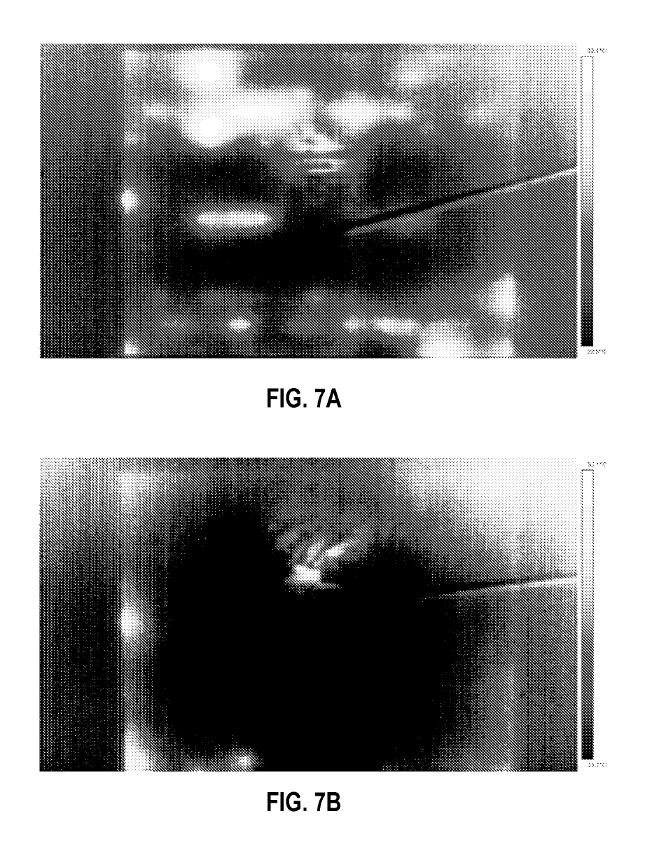

In detailed embodiments, a back-contact solar cell manufactured in the apparatus described with respect to FIG. 5 has a lower reverse bias defect than a back-contact solar cell manufactured without the support fixture 200. FIG. 6 shows the back side of a substrate after laser drilling. The top and bottom rows of vias were drilled with the substrate spaced a distance from the aluminum support fixture, while the middle row of vias was drilled with the substrate contacting the aluminum support fixture. FIG. 7A shows a forward-looking infrared scan (FLIR) of a via drilled with the substrate contacting the support beneath the via. FIG. 7B shows an FLIR of a via drilled with the substrate supported a distance from the fixture. The bright spots in the images show “hot spots” or reverse bias defects (shunting).

Reference throughout this specification to “one embodiment,” “certain embodiments,” “one or more embodiments” or “an embodiment” means that a particular feature, structure, material, or characteristic described in connection with the embodiment is included in at least one embodiment of the invention. Thus, the appearances of the phrases such as “in one or more embodiments,” “in certain embodiments,” “in one embodiment” or “in an embodiment” in various places throughout this specification are not necessarily referring to the same embodiment of the invention. Furthermore, the particular features, structures, materials, or characteristics may be combined in any suitable manner in one or more embodiments. The order of description of the above method should not be considered limiting, and methods may use the described operations out of order or with omissions or additions.

It is to be understood that the above description is intended to be illustrative, and not restrictive. Many other embodiments will be apparent to those of ordinary skill in the art upon reviewing the above description. The scope of the invention should, therefore, be determined with reference to the appended claims, along with the full scope of equivalents to which such claims are entitled.

What is claimed is:

1. An apparatus for drilling a high density of via holes in a semiconductor substrate during the manufacture of a back-contact solar cell comprising:
a laser having power sufficient to form the high density via holes in the semiconductor substrate;
a semiconductor substrate support fixture spaced from the laser, the support fixture substantially comprising ceramic material, the support fixture including a main body portion, a plurality of apertures through the main body portion, and a plurality of spaced apart standoffs that contact the semiconductor substrate and hold the semiconductor substrate at a distance away from the main body portion; and
a vacuum source coupled to the apparatus to supply a vacuum pressure through the apertures in the support fixture sufficient to hold the semiconductor substrate during the high density via hole drilling process.

2. The apparatus of claim 1, wherein the semiconductor substrate is held a distance from the main body sufficient to allow the laser to become defocused.

3. The apparatus of claim 1, wherein the plurality of standoffs are positioned to rest on bond pad regions of the semiconductor substrate.

4. The apparatus of claim 1, wherein the top of the plurality of standoffs have chamfered tops.

5. The apparatus of claim 1, wherein the semiconductor substrate is positioned a distance from the main body in the range of about 0.5 mm to about 5 mm.

6. The apparatus of claim 1, wherein the ceramic material comprises alumina.

7. The apparatus of claim 1, wherein the ceramic material has a melting point that minimizes ablation of the ceramic material during a high density via hole drilling process to decrease shunt resistance in a finished back contact solar cell.

8. The apparatus of claim 1, wherein the plurality of standoffs are integrally formed with the main body portion.

9. The apparatus of claim 1, wherein the main body portion and the plurality of standoffs are formed separately.

10. The apparatus of claim 1, wherein a back-contact solar cell manufactured has a lower reverse bias defect than a back-contact solar cell manufactured without the support fixture.

11. A method of processing a semiconductor substrate comprising:
positioning a semiconductor substrate on a plurality of standoffs on a support fixture, the support fixture substantially comprising ceramic material, the standoffs holding the substrate a distance from a main body, the support fixture including a plurality of apertures; and
drilling a plurality of via holes in the semiconductor substrate with a laser.

12. The method of claim 11, wherein the ceramic material has a melting point that minimizes ablation of the ceramic material during a high density via hole drilling process to decrease shunt resistance in a finished back contact solar cell.

13. The method of claim 11, further comprising applying a vacuum sufficient to hold the semiconductor substrate against the standoffs during the high density via hole drilling process.

14. The method of claim 11, wherein the semiconductor substrate is held a distance from the main body sufficient to allow the laser to become defocused.

15. The apparatus of claim 1, wherein the plurality of standoffs are positioned to rest on bond pad regions of the semiconductor substrate.

16. The apparatus of claim 1, wherein the top of the plurality of standoffs have chamfered tops.

17. The apparatus of claim 1, wherein the semiconductor substrate is positioned a distance from the main body in the range of about 0.5 mm to about 5 mm.

18. The apparatus of claim 1, wherein the ceramic material is alumina.

19. A semiconductor support fixture comprising:
a main body portion comprising a plurality of apertures; and
a plurality of spaced apart standoffs configured to contact a semiconductor substrate and hold the semiconductor substrate a distance from the main body portion,
wherein the main body portion and the spaced apart standoffs substantially comprise ceramic material.

20. The semiconductor support fixture of claim 19, wherein the ceramic material is alumina.
